(19) United States
(12) Patent Application Publication
(10) Pub. No.: US 2017/0046748 A1
(43) Pub. Date: Feb. 16, 2017

(54) METHOD AND SYSTEM FOR PERSONIFYING A BRAND

(71) Applicant: Juji, Inc., Saratoga, CA (US)

(72) Inventors: Michelle Xue Zhou, Saratoga, CA (US); Huahai Yang, San Jose, CA (US)

(21) Appl. No.: 14/855,764

(22) Filed: Sep. 16, 2015

Related U.S. Application Data
(60) Provisional application No. 62/204,345, filed on Aug. 12, 2015.

(51) Int. Cl. G06Q 30/02

(52) U.S. Cl. CPC G06Q 30/0276

(57) ABSTRACT

The present teaching relates to personifying a brand. In one example, information associated with a brand is received. Based on the received information, data related to the brand is retrieved. The data includes information indicative of desired market impression associated with the brand. The data is transformed to derive at least one brand persona that characterizes the brand based on the information.

### CROSS-REFERENCE TO RELATED APPLICATION

The present application claims priority to U.S. Provisional Patent Application No. 62/204,345, filed Aug. 12, 2015, entitled “METHOD AND SYSTEM FOR PERSONIFYING A BRAND,” which is incorporated herein by reference in its entirety.

### BACKGROUND

1. Technical Field

The present teaching relates to methods, systems, and programming for personifying a brand.

2. Discussion of Technical Background

A brand is a perception that people have about a “thing”, such as an individual, an organization, a product, or a service. Personifying a brand is to create the perception of the “thing” as if it were a person with distinct qualities (e.g., a Hero vs. a Sage), which enables the brand to better connect with people and differentiate itself from other brands.

Most existing techniques for personifying a brand rely on surveys that solicit people's perceptions of a brand as a person and how this person would think and feel. However, such approaches are not reliable and scalable, not mentioning their cost.

Therefore, there is a need to develop techniques for personifying a brand to overcome the above drawbacks.

### SUMMARY

The present teaching relates to methods, systems, and programming for brand personification.

In one example, a method, implemented on a machine having at least one processor, storage, and a communication platform connected to a network for personifying a brand. Information associated with a brand is received. Based on the received information, data related to the brand is retrieved. The data includes information indicative of desired market impression associated with the brand. The data is transformed to derive at least one brand persona that characterizes the brand based on the information.

In a different example, a system having at least one processor, storage, and a communication platform connected to a network for personifying a brand is disclosed. The system comprises a brand persona establishment unit configured for receiving information associated with a brand; retrieving, based on the received information, data related to the brand, wherein the data includes information indicative of desired market impression associated with the brand; and transforming the data to derive at least one brand persona that characterizes the brand based on the information.

Other concepts relate to software for implementing the present teaching on brand personification. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for personifying a brand, according to an embodiment of the present teaching;

FIG. 2 is a high level depiction of another exemplary networked environment for personifying a brand, according to an embodiment of the present teaching;

FIG. 3 illustrates an exemplary diagram of a brand personification engine, according to an embodiment of the present teaching;

FIG. 4 illustrates an exemplary diagram of a brand persona establishment unit, according to an embodiment of the present teaching;

FIG. 5A and FIG. 5B show a flowchart of an exemplary process performed by a brand persona establishment unit, according to an embodiment of the present teaching;

FIG. 6 illustrates an exemplary diagram of a brand persona presentation unit, according to an embodiment of the present teaching;

FIG. 7 is a flowchart of an exemplary process performed by a brand persona presentation unit, according to an embodiment of the present teaching;

FIG. 8 illustrates an exemplary diagram of a brand persona management unit, according to an embodiment of the present teaching;

FIG. 9 is a flowchart of an exemplary process performed by a brand persona management unit, according to an embodiment of the present teaching;

FIG. 10 illustrates content in brand personification databases, according to an embodiment of the present teaching;

FIG. 11 illustrates content in a knowledge database, according to an embodiment of the present teaching;

FIG. 12 depicts the architecture of a mobile device which can be used to implement a specialized system incorporating the present teaching; and

FIG. 13 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of personifying a brand that represents an individual, an organization, a product, or a service. Brand personification embodies a brand with unique, human-like characteristics and qualities. For example, a brand like Harley-Davidson possesses a “rebel” persona with its brand personality stressing ruggedness and roughness, while a brand like Hallmark embodies a “lover” persona with a charming, sincere personality. Moreover, people related to a brand, e.g., customers and employees alike, also reflect the human-like qualities of the brand. Brand personification has many benefits to a brand, such as helping the brand to connect with its target audience more easily and better differentiate itself from other brands. For example, before a candidate accepts an offer to work for a brand, it would be easier for the candidate to make a decision if he knows what the brand stands for and what its employees are like. Similarly, it is easier to engage a new customer if the brand can show that it delights the people just like her.

To make brand personification more effective and more affordable to all individuals and organizations who want to establish a brand of their own, the present teaching focuses on using a data-driven, quantitative approach to automatically determine the human-like characteristics of a brand, including the brand's persona and associated brand personality. Moreover, the present teaching also extends the scope of the traditional brand personification process to capture the representative personas of its related people, such as its customers and employees. In addition to effectively determining and communicating distinct personas and associated human qualities for a brand, the present teaching can efficiently do so for hundreds of thousands of brands. Moreover, the automation supports dynamic, effective brand management based on the brand's personas and their evolutions so that proper brand actions (e.g., keeping the brand messages consistent across channels) can be taken to maintain the health of the brand as well as to grow the brand. As a result, the present teaching allows a brand owner/manager/agency to design, establish, communicate, and develop a brand more efficiently and effectively based on human characteristics and qualities, which are objectively determined by data and data analytics.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities, and combinations set forth in the detailed examples discussed below.

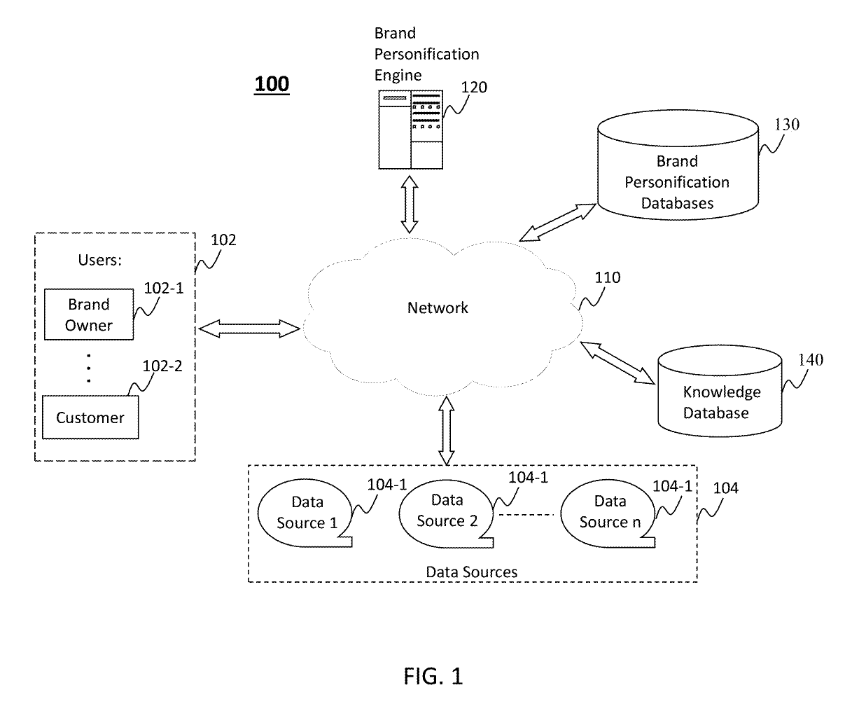

FIG. 1 is a high level depiction of an exemplary networked environment 100 for brand personification, according to an embodiment of the present teaching. In FIG. 1, the exemplary networked environment 100 includes one or more users 102, a network 110, a brand personification engine 120, brand personification databases 130, a knowledge database 140, and data sources 104. The network 110 may be a single network or a combination of different networks. For example, the network 110 may be a local area network (LAN), a wide area network (WAN), a public network, a private network, a proprietary network, a Public Telephone Switched Network (PSTN), the Internet, a wireless network, a virtual network, or any combination thereof.

Users 102 may be of different types such as a brand owner 102-1 who owns a brand, a customer 102-2 who has purchased a product of a brand, an employee who works for a brand (not depicted here), etc. In one embodiment, users 102 may be connected to the network 110 and able to access and interact with online content provided by the brand personification engine 120 through wired or wireless technologies and related operating systems implemented within user-wearable devices (e.g., glasses, wrist watch, etc.). A user, such as the user 102-1, may send a request for personifying a brand to the brand personification engine 120, via the network 110 and receive persona(s) characterizing the brand through the network 110.

The brand personification engine 120 may design/discover a brand's one or more personas, effectively communicate a brand's persona(s), and dynamically manage a brand based on its persona(s). The request for personifying a brand from a user to the brand personification engine 120 may specify one or more data sources 104 that contain data to be used by the brand personification engine 120 to determine the brand's one or more personas. The derived brand persona(s) can be stored in brand personification databases 130. The brand personification engine 120 can further connect to the knowledge base 140, which supplies various knowledge used to make various computational inferences as described below.

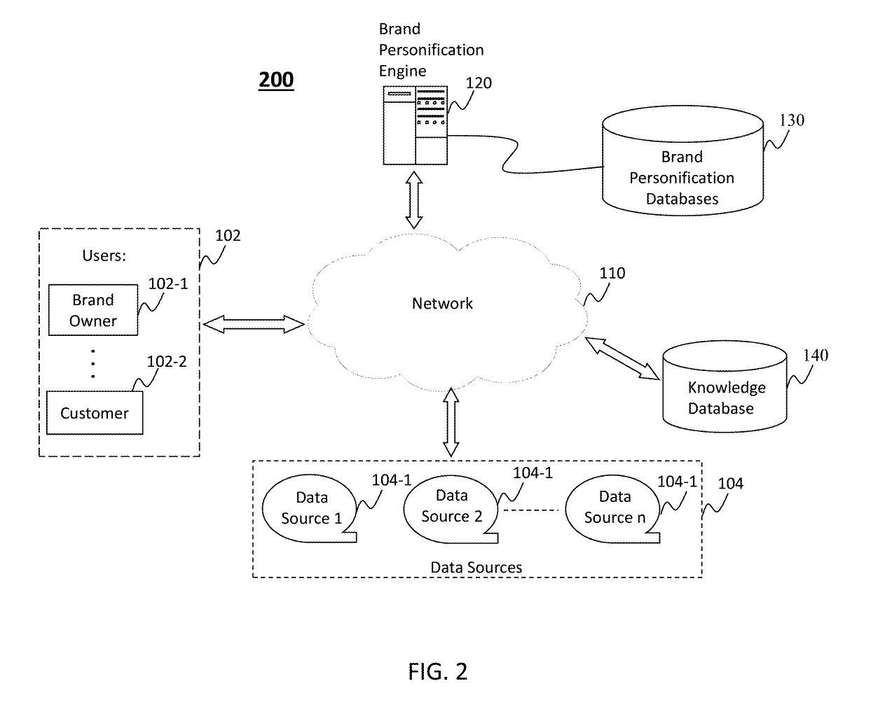

FIG. 2 is a high level depiction of another exemplary networked environment 200 for brand personification, according to an embodiment of the present teaching. The exemplary networked environment 200 in this embodiment is similar to the exemplary networked environment 100 in FIG. 1, except that the brand personification databases 130 serve as a backend system for the brand personification engine 120.

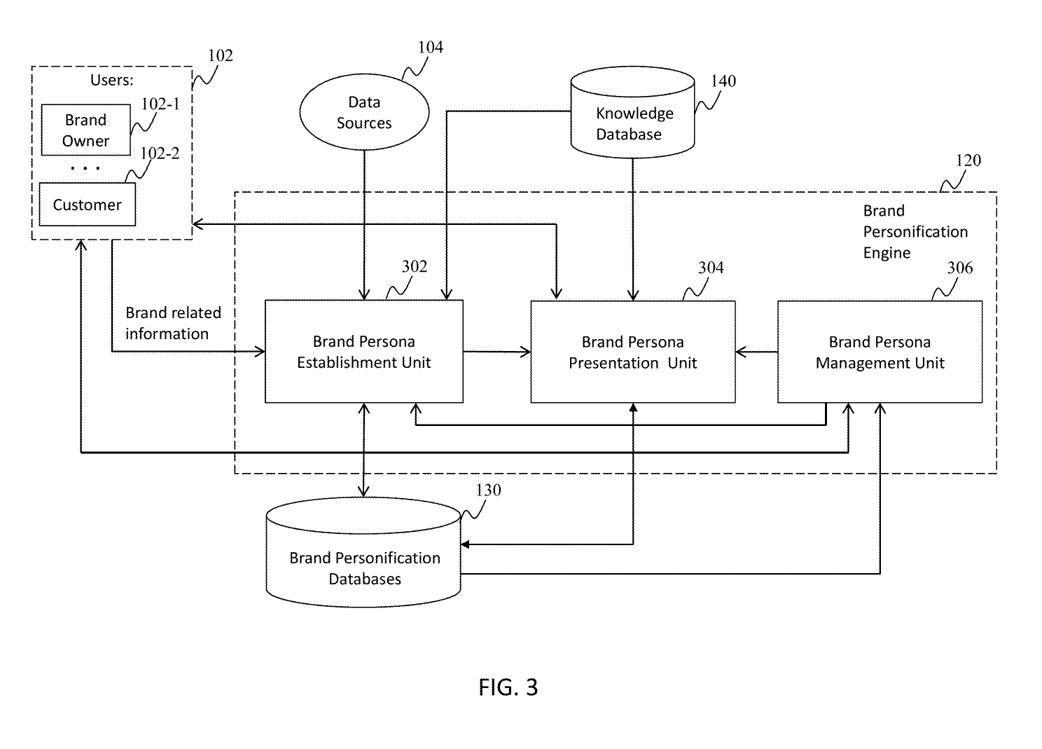

FIG. 3 illustrates an exemplary diagram of a brand personification engine 120, according to an embodiment of the present teaching. As shown in FIG. 3, the brand personification engine 120 in this example includes a brand persona establishment unit 302, a brand persona presentation unit 304, and a brand persona management unit 306.

Given the brand-related information, potential data sources 104, and a knowledge base 140, the brand persona establishment unit 302 analyzes the input data and automatically derives a brand's one or more personas and their associated human traits, which humanize a brand so that its intended audience, such as its customers, employees, and partners, can better bond and engage with the brand. The derived brand persona(s) are stored in brand personification databases 130.

A brand's persona(s) may be communicated in different ways to different audiences with different purposes. The brand persona presentation unit 304 takes a presentation request, directly from a user or from another component, and transforms the derived brand personas and their related information into a presentation for different users to consume. One exemplary presentation request is from a brand designers who wants to create brand assets (e.g., logo and mascot) based on the derived brand personas. In this case, the brand persona presentation unit 304 automatically generates a branding brief—instructions for designing the branding assets based on a brand's personas. Another exemplary request is to communicate the brand's personas to an intended audience, e.g., customers or employees. In this case, the brand persona presentation unit 304 automatically transforms the brand's personas and related information into human-comprehensible branding messages for the target audience.

Since a brand often evolves, the brand persona management unit 306 can support a dynamic management of the brand and obtain deep brand intelligence. Given a brand management request, the brand persona management unit 306 may request periodic update of a brand's personas (e.g. from the brand persona establishment unit 302 and the brand persona presentation unit 304), compute the brand health meter based on the updated personas and a set of brand health metrics, and automatically recommend brand management actions. Such management requests may also be on demand, such as during the process of composing a brand marketing message. In such a case, the brand persona management unit 306 automatically evaluates composed message and recommends revisions based on the brand health metrics. Moreover, the brand persona management unit 306 may also be used by a brand owner/manager to obtain collaborative/competitive brand intelligence based on their respective brand personas and the changes in such personas. The brand owner/manager may then use such intelligence to position the development/growth of a brand.

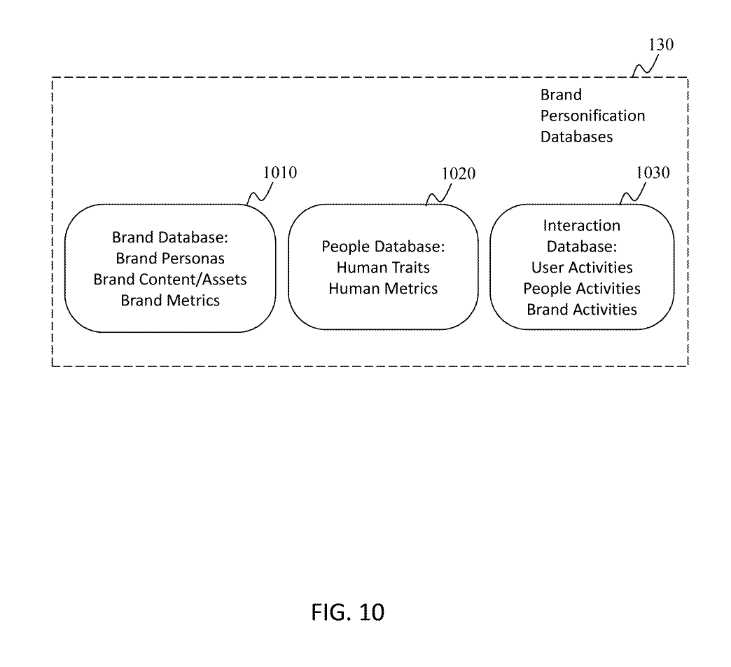

The brand personification engine 120 also connects to one or more databases 130. FIG. 10 illustrates content in the brand personification databases 130, according to an embodiment of the present teaching. As shown in FIG. 10, the databases 130 store different types of data, such as brand personification results as well as various relevant data for the engine and applications. One is a brand database 1010 that contains inferred brand personas and their associated human-like traits, including inferred brand personality traits. These personas may also be associated with a specific time stamp indicating when the personas are derived, a brand specification, and one or more data sources used to derive the personas. The brand database may also contain various brand content, such as product announcements, and target audience. The brand database further consists of a set of metrics that are used to measure a brand's health and brand behavior (e.g., level of personalization).

Another database is a people database 1020, which stores people associated with one or more brands and their traits (e.g., demographics, personality, and belief). The people database also stores “human metrics”, which are used to measure changes in a person (e.g., human need change).

Yet another type of data repository is an interaction database 1030, which stores various user interactions, brand-related people interactions, and brand-people interactions that an application captures. For example, in a brand design application, a brand owner may use the engine to create a brand persona design brief. Such interaction along with the resulted brief is captured in the interaction database. In another branding application example, a brand manager may tweet a brand promotional message, which may trigger interactions between the brand and its customers around this message, such as retweets, comments, and likes. Such interactions are all captured and stored in the interaction database.

The brand personification engine 120 further connects to the knowledge base 140, which supplies various knowledge used to make various computational inferences as described below.

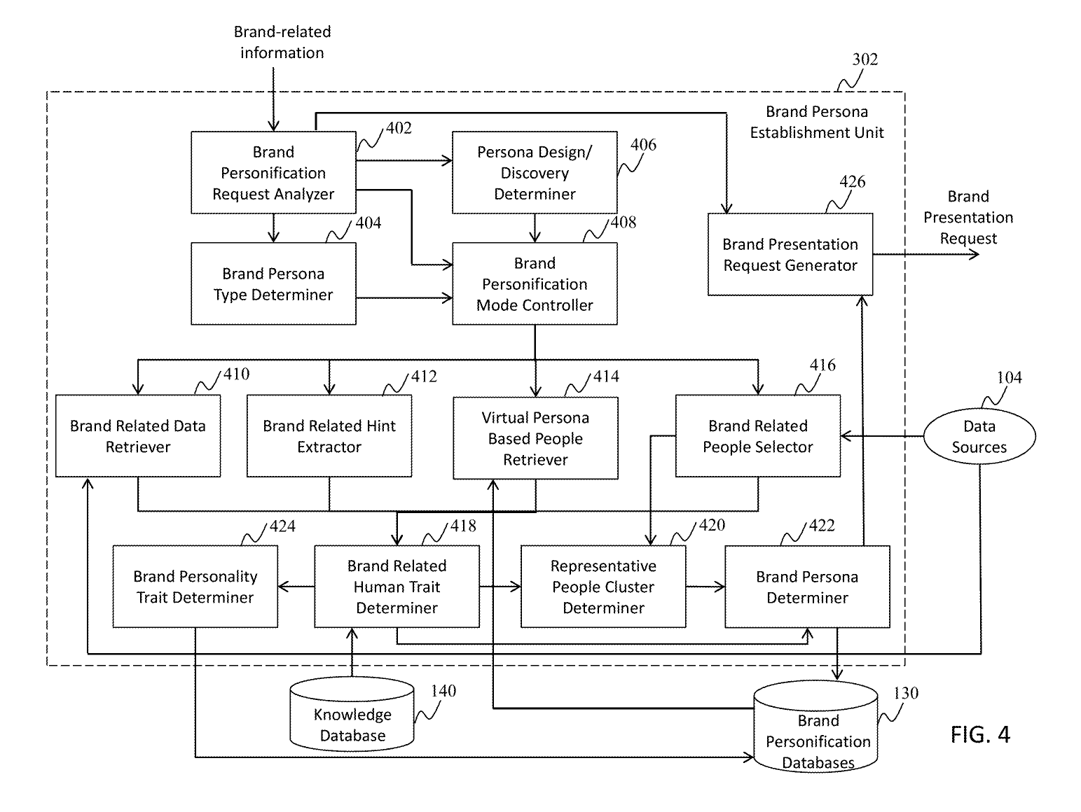

FIG. 4 illustrates an exemplary diagram of a brand persona establishment unit 302, according to an embodiment of the present teaching. A brand may be portrayed by one or two types of personas: (a) a brand's self persona(s), and (b) personas of people or other brands associated with a brand (e.g., customer personas, employee personas, and partner personas). A brand's own/self persona is normally expressed by the brand's own message and provides the brand with one or more human-like characteristics so that its intended audience can easily relate to the brand. Not only does a brand have its own unique persona, people related to the brand, customers and employees alike, also have their own distinct human traits and personas. The personas of the customer or employee reflect the meaning of the brand, and help the brand to better connect with people who can easily identify with those similar to them. The present teaching extends the traditional scope of brand personification to include the creation of representative personas of a brand.

Moreover, a brand's persona(s) are often determined in one of two situations. The first situation, called persona discovery, is when a brand has already generated certain activities, e.g., having a customer base. In this case, the brand should be able to use the relevant data generated so far, such as its own communication and the communication generated by people associated with it, customers and employees alike, to discover its persona(s). The second situation, called persona design, is when a brand tries to figure out what kind of persona(s) it should take on.

FIG. 4 depicts an exemplary embodiment of the brand persona establishment unit 302, illustrating how such a structural embodiment of the engine supports the determination of a brand's two types of persona(s) under each of the situations. Given a set of brand-related information, the Brand Personification Request Analyzer 402 processes the given input. Its result is then sent to the Brand Persona Type Determiner 404 to determine whether to determine a self persona, a representative persona, or both. The result is also sent to the Brand Persona Design/Discovery Determiner 406 to determine whether this is to design a brand's persona(s) from scratch or derive persona(s) automatically from existing data. The Brand Personification Mode Controller 408 takes the results from modules 404 and 406 as well as part of results from module 402 (e.g., relevant data sources) and routes the request to one of the following modules.

As described below, the brand-related information may include one or more types of data related to a brand. For the purpose of deriving brand personas, such data often conveys the desired market impression associated with the brand. By no means this is an exhaustive list of examples, here are some examples of such data: (1) a brand's own communication messages; (2) desired brand images by design such as brand persona hints or virtual personas mentioned below; (3) positive brand impressions captured by expressions and evaluations respect to the brand given by people directly associated with the brand, such as customers, employees, and partners, and (4) positive brand impressions given by third parties, such as media and business analysts.

If the mode is brand discovery and the type is self persona, the controller 408 calls the Brand Related Data Retriever 410, which retrieves the relevant brand data and sends the retrieved data to a Brand Related Human Trait Determiner 418. The Brand Related Human Trait Determiner 418 analyzes its input data (e.g., text or images), and then automatically derives a set of human traits that characterizes the brand. Depending on the trait models, as described below, the Brand Related Human Trait Determiner 418 may use different algorithms to automatically derive the human trait scores defined by a trait model. Here the term human traits refer to a person's psychological or biological characteristics and qualities. Psychological traits are used to characterize a person from aspects such as one's cognition, social interaction, and personality. Biological traits, on the other hand, characterizes a person from aspects, such as gender and age. The goal of this Brand Related Human Trait Determiner 418 is to treat a brand as if it were a person, and use its own data to characterize it via set of human traits. As a result, this step automatically computes one or more human trait scores from a brand's data. Each score is also associated with a confidence factor, which indicates the confidence in the derived trait. As described below, many algorithms may be used to derive human traits defined by a trait model.

The derived human trait scores are then sent to a Brand Persona Determiner 422, which determines the brand's one or more persona(s). Here a persona, is also known as an archetype, such as a Hero, a Sage, or a Magician, which provides the meaning of the brand as if the brand were a person. The Brand Persona Determiner 422 is to take a set of human trait scores and automatically compose one or more personas. The human traits derived by the Brand Related Human Trait Determiner 418 are also used by the Brand Personality Trait Determiner 424 to derive a set of brand personality traits. Although a brand may be characterized by a set of human traits as derived by the Brand Related Human Trait Determiner 418, a brand is not a person after all. Certain human traits may not make sense to portray a brand, e.g., “Neuroticism.” Thus brand personality models may be used to derive a sub-set of human traits to characterize a brand. The Brand Personality Trait Determiner 424 is to use the derived human traits to infer a set of brand personality trait scores. Although the brand personality traits may vary by different brand personality models, as described below, the inference approaches should be similar. The derived self personas by the Brand Persona Determiner 422 and brand personality traits by the Brand Personality Trait Determiner 424 are stored in the databases 130.

If the mode is persona design and the persona type to be determined is self persona, the controller 408 calls the Brand Related Hint Extractor 412. The Brand Related Hint Extractor 412 extracts the specified persona hints and the Brand Related Human Trait Determiner 418 then uses the hints to determine a set of related human traits. After the human traits are determined, they will then be sent to the Brand Persona Determiner 422 and the Brand Personality Trait Determiner 424 to determine the brand's one or more self personas and related brand personality traits, respectively, as described above. The results generated by the Brand Persona Determiner 422 and the Brand Personality Trait Determiner 424 are stored in the databases 130.

If the mode is persona design and the persona type to be determined is representative persona, the controller 408 calls the Virtual Persona Based People Retriever 414. The Virtual Persona Based People Retriever 414 processes the representative persona hints and uses the hints to retrieve one or more relevant people from the people database 1020 along with the data generated by the people. Given the retrieved people and their data, the Brand Related Human Trait Determiner 418 then automatically computes the trait scores for each person and sent the results to the Representative People Cluster Determiner 420. The Representative People Cluster Determiner 420 discovers one or more people clusters who may share one or more traits. Based on the discovered people clusters, the Brand Persona Determiner 422 determines the persona for each of the cluster. The determined persona(s) are also stored in the databases 130.

If the mode is persona discovery and the persona type to be determined is representative persona, the controller 408 calls the Brand Related People Selector 416. The Brand Related People Selector 416 selects and retrieves a set of people related to the brand, such as the customers or employees of the brand. The information is then used to retrieve the data generated by these people 410. The retrieved data is then sent to the Brand Related Human Trait Determiner 418 for human trait extraction. The extracted traits are then sent to the Representative People Cluster Determiner 420 to discover one or more people clusters who may share one or more traits. Based on the discovered people clusters, the Brand Persona Determiner 422 determines the persona for each of the cluster. The determined persona(s) are also stored in the databases 130.

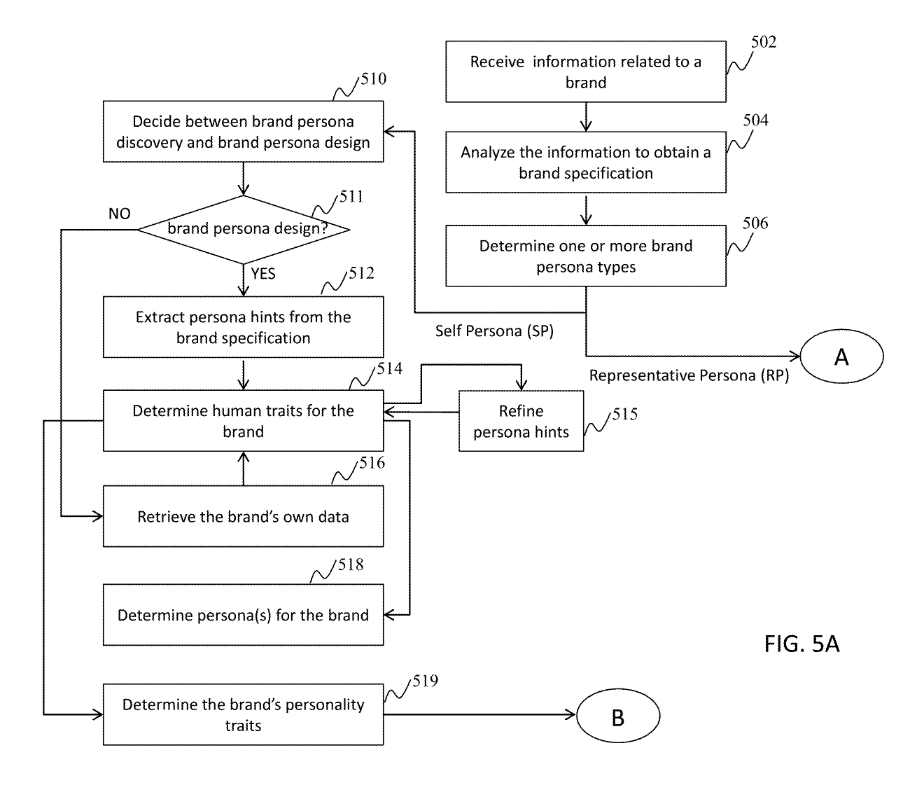

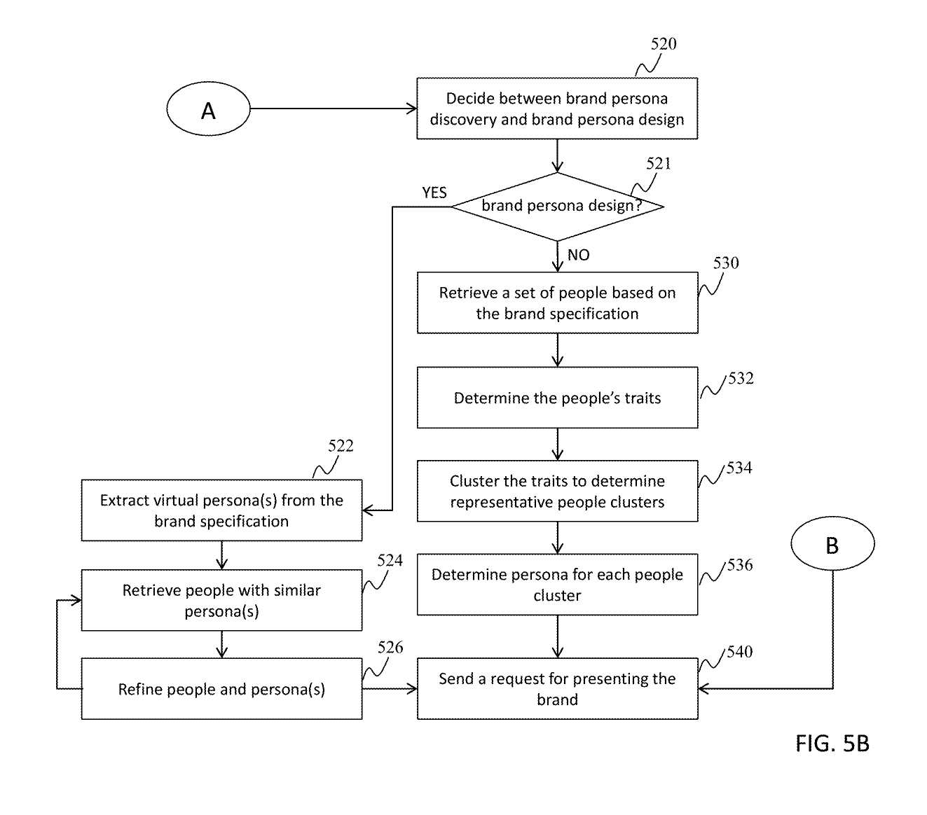

FIG. 5A and FIG. 5B show a flowchart of an exemplary process performed by a brand persona establishment unit, according to an embodiment of the present teaching. The process of determining a brand's one or more persona(s) starts with a set of brand-related information at 502. Such information is first analyzed to construct a brand specification at 504. The brand specification captures the type of persona to be determined: self persona, representative persona, or both. FIG. 5A captures the detailed flow on how to determine a brand's one or more self personas, while FIG. 5B shows how to determine a brand's one or more representative personas in details.

In FIG. 5A, to determine a brand's self persona, the process first determines the mode at 510. If the mode is persona discovery at 511 instead of persona design, the brand specification provides one or more data sources related to the brand. These data 104 are generated by a brand itself, such as its own external website content, Facebook page posts, tweets, blogs, and internal employee communication content. The process goes to 516, where the brand-generated data is retrieved. Then at 514, the signals in these data are analyzed and automatically used to infer a set of human trait scores.

One exemplary implementation of 514 is to derive a set of human traits defined by the Big 5 personality model. In this implementation, one or more algorithms may be used alone or together. One exemplary approach is to use a lexicon-based approach to derive Big 5 Personality Traits from text data. Such an approach includes a word-trait lexicon and an algorithm that computes a trait score based on the lexicon. A word-trait lexicon defines a set of words, and associates each word with a trait and a co-efficient. For example, word “awful” is associated with a Big 5 personality trait “Neuroticism” with a co-efficient of 0.26, while word “die” is associated with “Neuroticism” with a co-efficient of 4.6. Such a lexicon is stored as part of the knowledge base 140. The algorithm then processes the words in the text input (i.e., a brand's data) and computes the normalized frequencies of each word listed in the lexicon. It then computes a human trait score as the following:

$$S ( t ) = {\sum }_{i = 1}^{K} C ( {w}_{i} ) \times {co}_{i}$$

where S( ) is the score of human trait t, and words w₁, . . . , w_{K} are the K words associated with trait t in the word-trait lexicon and C( ) is the normalized count of a word appearing in the input text, and coᵢ is the co-efficient of wᵢ related to trait t.

Another exemplary algorithm is to extend the text lexicon-based approach (described above) to process other media signals, such as photos, images, and videos, used in communication. Instead of using a word-trait lexicon, it uses a visual-trait lexicon, where a photo, image, or video is associated with a human trait with a co-efficient. A trait score is then calculated based on the appearance of related photos/images/videos in the input data and their associated co-efficients to the trait.

As desired, different approaches that may be employed to infer human traits based on a different model, e.g. a model showing how to derive a different set of personality traits other than Big 5 personality traits based on one's email data. Although the Brand Related Human Trait Determiner 418 may employ different human trait models and/or computational approaches, its purpose is the same: automatically deriving one or more human trait scores related to a brand from the brand's own data.

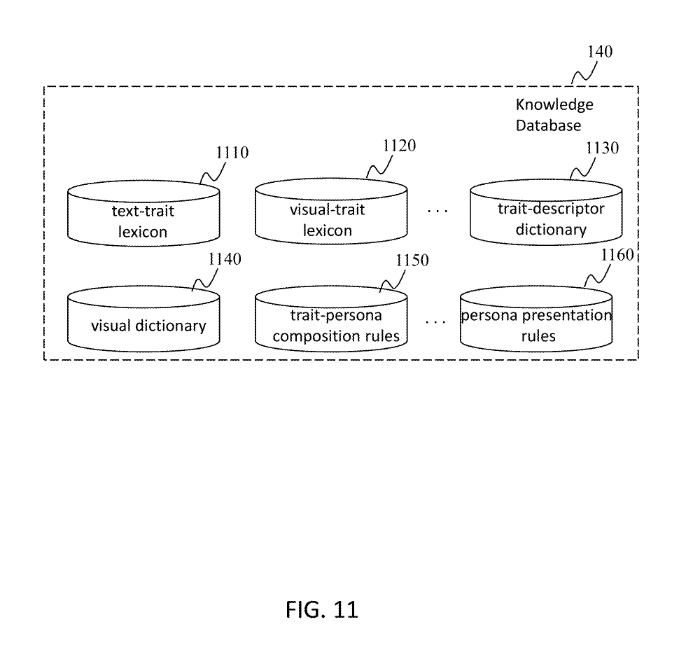

In the case of persona design, when the intent is to define a new brand, the brand specification (output of 504) provides one or more persona hints to indicate the kind of brand they wish to establish. Persona hints may be specified in words (e.g., “caring, warm, helpful”), and/or images, photos, and may be terse, vague, and free formed. Thus at 512, the hints are extracted from the brand specification first. At 514, the vague expressions of hints are transformed into corresponding human trait scores that a computer system can process in the future. Given the persona hints, one embodiment of 514 is to first construct a reverse trait dictionary (e.g. 1130 in FIG. 11), where each human trait is associated with a set of descriptors—a set of keywords and/or one or more images/photos (visual hints) describing the trait. For example, “Extrovert” a Big 5 personality trait, may be associated with one or more keyword descriptors as such: <social, 1.0>, <enthusiastic, 1.0>, <quiet, −1.0>, <cold, −1.0>. These keyword descriptors indicate that a high “Extrovert” score is described as “social” and “enthusiastic”, while a low Extrovert is associated with “quiet” and “cold”. In addition to text descriptors, images/photos may be descriptors too. Based on the reverse trait dictionary 1130, the next step is to to map the input hints against the trait descriptors in the dictionary to calculate each trait score in numerical or nominal value, depending on the format of the descriptors (e.g., <social, high> vs. <social, 1.0>). In case where the input keywords/images cannot be matched with any descriptors or the initial keywords are inherently ambiguous (i.e., they match multiple trait descriptors), the input is then augmented with one or more word synonyms and/or similar images to increase the probability to be matched. The augmentation process may be done manually such as soliciting more keyword/image input from a user, automatically by using a thesaurus dictionary or image/photo database, or a combination of the manual and automatic approach. The reverse trait dictionary described above is stored as part of the knowledge database 140. As a result, a set of human trait scores are determined based on the input hints.

Note that the above process is most likely an iterative process, which may require multiple iterations to derive related human trait scores. In case that few persona hints are matched with traits in the trait-descriptor dictionary 1130, the hints are refined at 515. In such a process may also require a human user in the loop, who could help guide the process, e.g., validating and refining machine-suggested matches. The refined hints are then used to derive human traits at 514. The process continues until a set of criteria is met (e.g., all hints are matched) or a humer user stops it.

After at 514 determining a set of human traits for a brand, at 518, it is determined one or more personas manifested by these trait scores. One may use one or more approaches to infer the related persona(s). One embodiment is to use a rule-based approach to derive one or more personas defined in a brand persona framework. In this approach, one or more rules define how different combinations of traits derive a particular persona defined by the brand persona framework. For example, one rule specifies that the composition of persona “Caregiver” defined in the framework is made by two traits:

IF S(“Altruism”)>threshold1 AND S(“Dutifulness”)>threshold2 THEN persona=“Caregiver” CF=0.7;

Here both “Altruism” and “Dutifulness” are personality traits in the Big 5 Personality model, and “Caregiver” is a well-known brand perona (archetype). CF indicates the confidence factor. Such rules are stored in the knowledge base 140. A rule engine then evaluates the satisfied conditions in each rule and triggers the firing of the rule to derive results.

Instead of using a rule-based approach, a machine learning approach may also be used. In such an approach, a set of training examples are first constructed. Such an example includes the derived human traits of a brand and a tag indicating the brand's persona, such as “Caregiver”. The examples are then used to train a statistical model, which is then used to predict a brand's persona with a probability given the set of the brand's human traits scores inferred at 514.

No matter which persona types or computational approaches are used, it is likely that the module outputs one or more personas for a brand. Since each persona is associated with a confidence score (e.g., from a rule-based approach) or probability (e.g., from a machine learning approach), such score may then be used to guide further actions. For example, in the process of persona design, two well-known personas “Caregivers” and “Sage” but with similar probability scores emerged. This may prompt the brand owner/designer to create a new persona that does not exist before to the branding world yet, such as “Smart Caregiver” vs. Caring Sage”, depending on which human qualities that the brand wants to emphasize. As shown later, such scores are also used to help evaluate the brand health.

One exemplary implementation of 519 is to compute the brand personality traits, using 5 brand personality dimensions, such as sincerity and sophistication, to describe a brand. To facilitate brand monitoring and comparison along these dimensions, at 519, a brand's personality trait scores are automatically determined. For example, this step may derive a total of 5 dimensions, 20 brand personality trait.

There are many approaches to the derivation of the brand personality trait scores. One embodiment at 519 is to transform human traits to brand personality traits identified in a model. The simplese transformation is to obtain a brand personality trait score by finding a matched human trait. For example, the “Cheerfulness” facet under “Sincerity” may be estimated by the trait “Cheerfulness”, a facet in the Big 5 personality model. If there is no direct mapping between a brand personality trait to a human trait, then a composition may be used. For example, the trait score of “Reliability” may be composed of two Big 5 personality traits (“Achievement-Striving” and “Self-Discipline”):

S(“Reliability”)=0.5*S(“Achievement-Striving”)+0.5*S(“Self-Discipline”), where S(t) is the score of trait t.

As a result, at 518, one can compute all brand personality trait scores either based on a direct mapping of or a composition of one or more human traits derived from 514. Note that the same approach may be used no matter which underlying brand personality model or human trait model is used, as long as certain types of mappings are established between the two models.

Similar to the process of determining a brand's self persona(s), the process in FIG. 5B of determining representative personas of relevant people also supports two modes: persona discovery and design.

Step 520 decides the mode of the design. If the mode is persona design at 521, it means that there is no sufficient data for automatically deriving the relevant people's pesonas. Therefore, the brand specification includes one or more desired virtual personas. For example, <“Persona-1”, “methodical, open-minded, conscientious”, 30%> specifies a name (“Persona-1”, which may be updated later), the associated characteristics, and the percentage of the customers likely represented by this persona. One or more virtual personas may be specified. The first step is to extract the virtual persona specifications from the input at 522. The next step at 524 is to retrieve one or more real-world people from the people database 1020 whose traits match with the characteristics of the virtual personas. This process is most likely an iterative process especially when initially only partial matches are found. Specifically, the retrieval algorithm initially may find people who match only certain specified traits of a virtual persona but none that matches all the specified traits. In such cases, a human user may be involved to interactively modify the matching criteria and evaluate matching results, such as revising the trait descriptors of the virtual persona and/or deciding on using one set of partial matches at 526. The revised specification are then used to find better matches at 524. As a result, one or more virtual personas may be created with mappings to the real-world people. Moreover, the traits of these virtual personas are also enriched by the traits of the matched real people (e.g., their demographic traits such as gender, age, and psychological traits such as Big 5 personality traits). The resulted personas may then be sent to be presented at 540.

In the case of “persona discovery”, step 530 retrieves the data generated by a set of people related to a brand, such as a brand's customers and/or employees. Normally, the people related to a brand are specified as one or more data sources. For example, a specification may include the brand's customer-facing Twitter account, using which the step 530 identifies a set of customers based on their conversations with the brands on Twitter. It then gathers the content generated by this set of customers, such as their tweets. In another example, a specified employee-facing communication data source allows step 530 to identify a set of employees and collect their generated data. The data collected at 530 is sent to be used at 532, which then determines a set of traits for each person based on their data.

While the process of deriving a person's traits at 532 is similar to the methods described at 514 in FIG. 5A, the process may be altered for several reasons. Comparing to a brand, the data generated by an individual for analysis may not be sufficient. For example, a person might have only generated 100 tweets, which are far fewer than what a brand would generate. This process thus may compute a reliability metric to measure how stable the generated traits are. This may be done by comparing the variances in generated traits given different amounts of available data.

After deriving each person's traits, step 534 discovers representative people clusters by their traits. Discovering people clusters may be mapped to a clustering problem—a main task of exploratory data mining. Depending on the requirements of a user (e.g., a brand owner or a branding agency consultant), there are multiple implementations to derive the representative people clusters.

If the desired number of people clusters to be derived is known, one of many clusering approaches, such as hierarchical clustering, may be employed to automatically produce the user-specified number of people clusters by people's traits. A user may further select the produced clusters that satisfy certain criteria (e.g., a cluster must exceed a certain size threshold) as representative people clusters. The thresholds may be determined empirically, e.g., requiring a cluster size to cover at least 20% of people analyzed since smaller clusters represent only a small population and are not that meaningful. Since each person may be characterized by a large number of traits, an enhancement to traditional clustering approaches is to perform feature selection first. Here it is to select a set of human traits first based on a set of criteria. For example, a statistical method like principal component analysis (PCA), may be used to first select a set of features (human traits) that satisfy certain criteria (e.g., traits that are orthogonal to each other with largest variances) and then use the selected traits are used to find people clusters. Yet another embodiment of discovering representative groups is to perform feature selection and clustering at the same time to further improve the qualities of found people clusters (groups).

In case that the desired number of people clusters is unknown, which is often the case, one may implement an enhanced co-clustering algorithm. The input to the algorithm is a large matrix, where each row represents a person and each column represents a person's trait derived from the last step 532. The output is a smaller matrix where each column represents a group of traits (called a trait group, and each row represents a people cluster. Here each people cluster (row) is characterized by a set of trait groups (columns). For example, for brand A, our algorithm automatically discovers three trait groups, trait group 1={“conscientiousness”, “self-discipline”}, trait group 2={“Neuroticism”, “Anxiety”, “Hostility”}, trait group 3={“Sympathy”, “Achievement”}, and two people clusters, cluster 1={{trait group 1: 22%}, {trait group 2: 79%}, {trait group 3: 56%}}; and cluster 2={{trait group 1: 68%}, {trait group 2: 54%}, {trait group 3: 58%1}}. This states that people in cluster 1 are rated low on the traits in the trait group 1 (22%, indicating that they are not very self-disciplined and conscientious), high on trait group 2 (79%, indicating they are easily emotionally not very stable and easily agitated), and about the average on trait group 3. On the other hand, people in cluster 2 are rated high on the first trait group (they are high conscientious and disciplined) but on average along the other two trait groups. In summary, this algorithm identifies two clusters of very different people: one group is careless and emotionally unstable, white the other group is highly disciplined and conscientious.

This algorithm derives representative people clusters in three key steps. The first-step is to use an optimization-based co-clustering algorithm to find a small matrix described above. Instead of requiring the specification of the desired numbers of rows and columns, our algorithm automatically optimizes the choices of these parameters by using a greedy descent approach that minimizes the residue sum of squared (RSS) and Akaike Information Criteria (AIC). This optimization achieves both good quality approximation of the original matrix and avoids over-fit. In lieu of a greedy descent optimization approach, many other optimization-based approaches may also be used, such as a stochastic search.

After obtaining a matrix consisting of people clusters and trait groups from the first step, the next step is to produce the most differentiating set of people clusters. To do so, this step first computes the similarities between every two clusters based on their related trait groups, and sorts the similarities from the most to the least similar. It selects the two most similar clusters to be merged and measures the entropies of the clusters before and after the merge. It tracks the changes in these entropies. It merges the two clusters if such change does not exceed a threshold (e.g., 3 Standard deviations). It then repeats the process and continues the merging process. Otherwise, it stops the merge.

The last step is to select a minimal number of the most representative trait groups associated with each people cluster. This step first measures the relative entropy of trait groups (column) and removes those that are not sufficiently varied by a threshold. This step will retain trait groups that uniquely identify each cluster.

As a result, step 534 identifies a set of representative trait clusters, each of which is characterized by a set of human traits and one or more meta attributes, which characterize a cluster. For example, meta attribute “coverage” describes the size of a cluster as how many people in the selected group are covered by this cluster, and meta attribute “purity” indicating how homogeneous the group is along certain trait dimensions.

Using the results produced at 534, step 536 uses one or more methods to determine a persona with each representative people cluster. Unlike a brand's persona (archetype) framework, which enumerates a limited number of personas, personas representing real humans are numerous. For example, there are different persona frameworks for characterizing travelers, foodies, fashionista, and entrepreneurs. Thus, one method to derive the representative persona of a people cluster is to leverage human intelligence via a crowd-sourcing method to come up with the persona. A method similar to the rule-based method mentioned at 518 may also be used to compose a persona based on the shared traits of the people cluster. For example, the rule below indicates that the composition of high “Extrovert” and high “Openness” in a travel domain creates a “creative, social traveler” persona:

IF S(“Extrovert”) is high AND S(“Openness”) is high THEN persona=“creative, social traveler” CF=0.8;

Unlike composing a brand persona (archetype), which is often based on a brand persona framework, human persona composition rules may be formulated based on various theoretical personality composition models, such as domain-specific models like the Holland career persona model.

The derived people clusters and their representative personas are all stored in the brand database 1010 and linked to the people related to the brand, whose derived traits are stored in the people database 1020. The results may also be sent to be presented at 540.

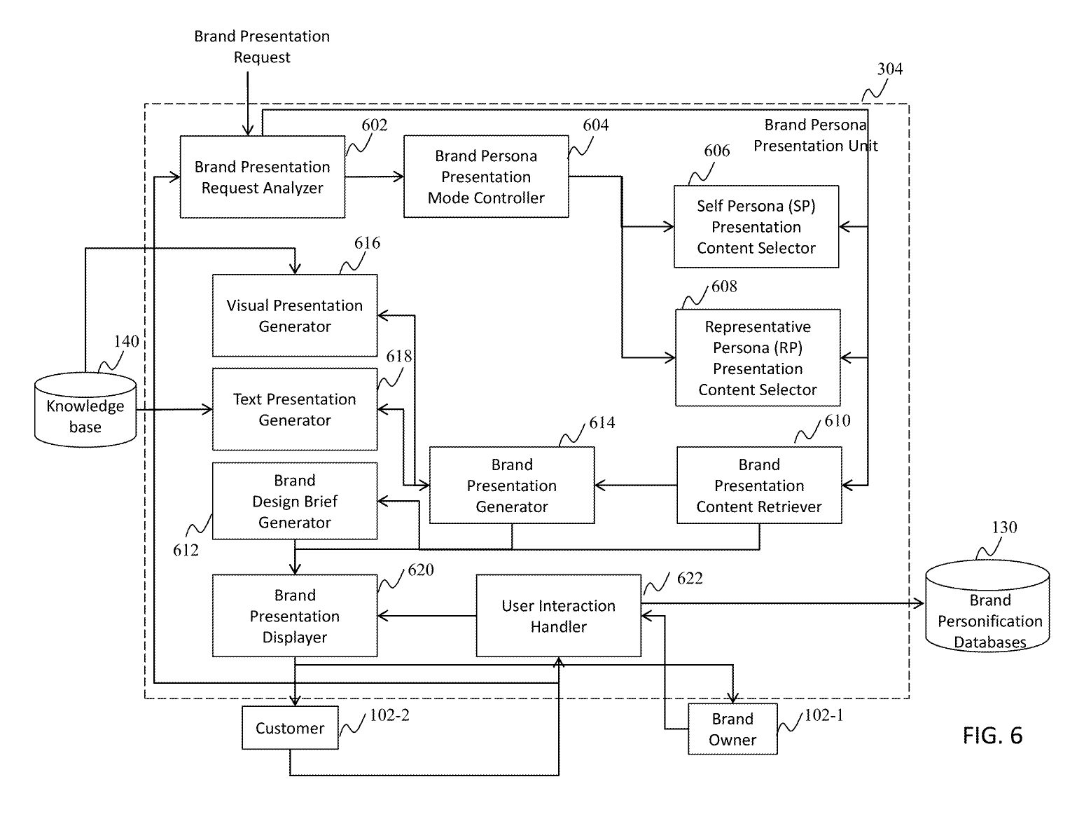

FIG. 6 illustrates an exemplary diagram of a brand persona presentation unit 304, according to an embodiment of the present teaching. As described earlier, one of the goals for personifying a brand is to communicate the brand in the way that its intended audience, including customers and employees alike, can better relate to and engage with the brand. FIG. 6 illustrates one of structural embodiments of the major functional blocks in communicating a brand's one or more personas to its intended audiences, such as a brand's owner/manager, customers, and employees.

As shown in FIG. 6, the Brand Persona Presentation Unit 304 starts with a Brand Presentation Request, which is directly specified by a user or generated by another component (e.g., the Brand Persona Management Unit 306 may generate a presentation request after a brand's personas has been updated). Such a brand persona presentation request often contains several types of information, such as the type of brand persona to be presented and the type of presentation to be created. The type of persona to be presented includes: self persona, representative persona, or both. There are two major types of presentation to be created: a design brief and a final presentation. Here a design brief often consists of a set of design instructions intended for users, such as a brand designer, to create various branding assets, such as a brand's logo, color, mascot. On the other hand, a final presentation such as a marketing message may be requested, which often includes a visual and/or textual representation of a brand's personas along with related information (e.g., products), to communicate the brand's image and messages.

A brand presentation request is first processed by a request analyzer 602. The analyzed request is then used by a request controller 604, which routes the request to different modules to be fulfilled. If the request asks the self persona to be presented, the Self Persona (SP) Presentation Content Selector 606 is called to determine the content related to the self persona to be presented. Similarly, the Representative Persona (RP) Presentation Content Selector 608 is activated to determine the content related to the representative persona to be presented. Based on the selected content, the Brand Presentation Content Retriever 610 retrieves the actual data to be communicated. If the presentation type is “design brief”, the presentation content retrieved by the Brand Presentation Content Retriever 610 is then sent to the design brief generator 612 to create one or more design briefs. The created brief(s) are then sent to the displayer 620 to be displayed to a user. If the presentation type is “marketing message”, the presentation generator 614 is then called to synthesize a presentation together. It dispatches certain content to a visual presentation generator 616, which creates a visual representation, and sends certain content to a text presentation generator 618, which generates a text representation. Both visual and text presentation generators connect to the knowledge base and use the presentation knowledge stored there to create a presentation. The Brand Presentation Generator 614 then composes the visual and text representations to create a final presentation. The final presentation is then sent to displayer 620 to be displayed. A user, such as a customer or owner of the brand, may also interact with the generated display, which is either a marketing message or a design brief. Interactions are captured in the databases and handled by an interaction handler 622. Depending on the user interactions, the displayer 620 may be called to update its display immediately (e.g., objects highlighting) and/or a new presentation request may be generated to trigger the generation of a new presentation (e.g., displaying more detailed information related to a brand on demand).

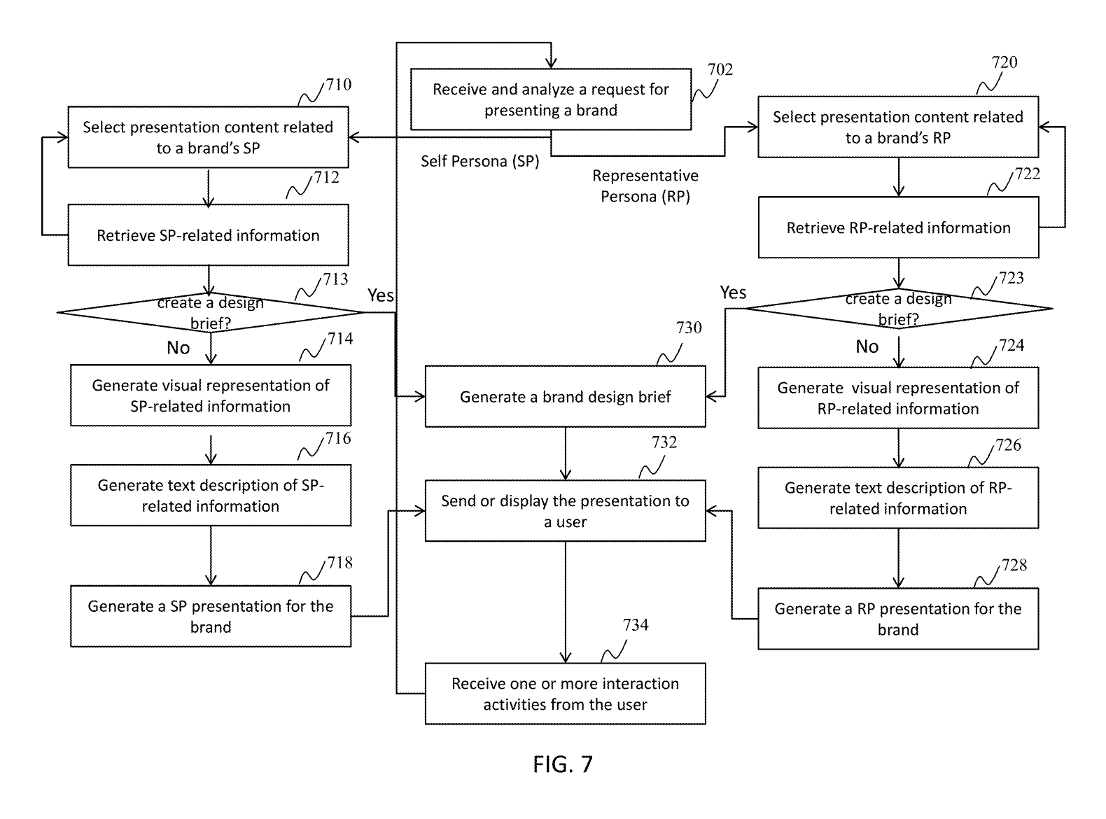

FIG. 7 is a flowchart of an exemplary process performed by a brand persona presentation unit, according to an embodiment of the present teaching. Given a brand persona presentation request, FIG. 7 provides a detailed process flow on taking such a request to output a requested brand persona presentation. The process starts with such a request, which is first analyzed to determine which persona(s) to be presented. If the request indicates the presentation of a brand's self persona(s), the sub-process of presenting the brand's one or more self personas is invoke. If the request also asks for the presentation of the brand's one or more representative personas, the process of creating a presentation of conveying the brand's one or more representative personas is also called.

A brand may possess one or more self personas, each of which is associated with a set of information, such as the related human traits, brand personality traits, and even product information. Step 710 selects a set of related information based on several presentation criteria. One such criterion is “brand clarity”, which requires to convey the most dominate persona of a brand to present a distinct image of the brand. Although there may be many approaches to select a dominate persona, one approach is to select a person with the highest salience score, which may be determined by the confidence factor or probability score associated with a derived persona (see 422 in FIG. 4). In case there are multiple personas with the same or very similar salience scores, then all the top-N personas will be selected, where N is determined by the number of personas ranked at the top based on their confidence score.

Based on a selected dominate persona, step 710 also selects one or more types of relevant information to depict the persona. One type of information is to present the human traits associated with each persona. Since there may be hundreds of derived human traits associated a brand's dominate persona, this step is to select one or more that distinguish a persona. A typical, simple approach is to identify traits with a boundary score—a trait score that greatly exceeds a certain threshold over or below the average score. Another exemplary approach is to identify traits that contribute the most to the make up of a persona. Recall one of the implementations of using human traits to derive a persona at 518. Different human traits contribute to a persona differently (e.g., either defined by a rule or formula). Here the traits with the biggest weights may be selected to convey the persona since these traits characterize the persona most distinctly. The same approaches of selecting distinct human traits may also be used to choose the most distinct brand personality traits to characterize a brand's personality associated with a dominate persona. Sometimes, it may be useful to communicate one or more meta properties of a derived self persona, which gives a user more information about the confidence or quality of the derived persona. Such meta properties include the computed confidence factor or probability score associated with a persona. Moreover, additional information such as a brand's meaning, which indicates a brand's benefits may also be included. Such information may be pre-authored and stored with each persona. To further substantiate a brand's meaning, module 710 may also include one or more example products/services offered by the brand. For example, one of the key benefits for a brand persona known as Sage is to teach its customers to learn knowledge. In this case, enumerating one or more of the brand's products that achieve such effects helps concertize the brand's meaning/benefits for its Sage persona.

If the presentation request asks to generate a design brief—a set of design instructions that help a brand create various communication assets, such as a logo, a font, a mascot, and a color, step 710 also provides one or more example designs, such as the communication assets of similar brands. The similar brands are decided by comparing the similarity of their self personas. A brand's assets are stored with a brand in the brand databases 1010, so their communication assets can then be retrieved from the database.

In summary, step 710 selects at least one or more types of information to represent a brand's self personas: One or more dominate self prsonas; One or more distinct human traits of each dominate persona; One or more distinct brand personality traits; One or more meta properties of the personas; The brand's meaning related to the persona—how the brand is expected to benefit others; One or more example products that demonstrate the aspects of each dominate persona; One or more examples of similar brands based on their self personas (for design brief); One of more examples of brand assets of similar brands based on their self personas (for design brief).

Given the retrieved brand content, step 730 synthesizes a design brief. A design brief may be generated based on a template, where each section is filled by one or more pieces of information identified above. For example, one design brief template for the purpose of creating a brand logo may include the following aspects: The brand's meaning; The brand's dominate persona; The brand's personality traits associated with the persona; One or more examples of brand logos from 3 similar brands.

Based on this template, each section is filled by the required information and the filled template is then sent to the displayer at 732 to be displayed to a user. In case where a final presentation is requested, step 718 synthesizes a presentation of a brand's self persona with related information using a combination of visual metaphors and text elements. To create the visual representation of a brand persona, step 714 may automatically selects proper visual metaphors that match a persona. Here visual metaphors may be pre-designed visual symbols that reflect the persona's main qualities (e.g., a unique visual character symbolizes a Caregiver and another for a Ruler), or animate/inanimate icons that are often associated with the persona (e.g., a Rulers's throne or a Caregiver's heart). These pre-designed visual symbols and icons are stored in the knowledge base 140. Text description may be introduced to convey the meaning of a brand as well at 716. A a brand's personality traits, on the other hand, may be displayed graphically (e.g., in a bar chart) or verbally (e.g, in a list). Meta properties of a derived persona, such as the confidence factor, may also be encoded graphically (e.g., a bar) and/or in text.

In addition to portraying a brand's own persona(s), step 720 selects a set of content to communicate a brand's one or more representative personas, derived from the people associated with the brand. If a brand (normally a big brand name) is associated with a large number of representative personas, step 720 may select a set of most representative personas. Such selection may be based on one or more criteria, such as the coverage of a representative persona or distinctiveness of a persona. For example, by the coverage criteria, the selection result is one or more representative personas such that their corresponding people clusters together cover the brand's most of customer or employee population. In contrast, by the distinctiveness criteria, the selection result is one or more representative personas such that their corresponding people clusters have the least number of shared human traits. In some cases, one or more criteria may be preferred. In such cases, the process balances the selection to meet all criteria as much as possible. The selection criteria may be set by a user or by an application's default configuration.

Given a representative persona, step 720 further selects one or more types of related information to describe or substantiate the persona. Similar to step 710, it may select one or more distinct human traits associated with each persona to present, and one or more meta properties of the derived persona, corresponding people cluster, or the derived human traits. One interesting meta property is the distribution of various traits of people in a people cluster. Such information provides additional insights into a people cluster, which describes the make of a derived persona at a finer grained level. Since each representative persona is derived from a people cluster, it may be useful to substantiate the persona using realistic examples. Such examples may include one or more representatives from the cluster, and the content generated by the representatives related to the brand (e.g., their product reviews). The representatives may be chosen based on different selection criteria. One exemplary approach is to select representatives from a people cluster whose trait scores are most similar to the most distinct human trait scores described above. Another exemplary approach is to select representatives by random sampling. Yet another exemplary approach is to select representatives by their level of engagement, which measures how much interaction a person has had with the brand, e.g., Twitter or Facebook conversation. Furthermore, associating product offerings with different personas helps convey the intended audience of the product. Thus, for each chosen representative persona, module 720 may also include one or more associated products. In case the presentation type is design brief, step 720 may also select examples of similar brands by comparing their representative personas. Associated with the example brands, information such as their representative personas and corresponding brand assets is then included to provide an intended designer more concrete information.

In summary, step 720 selects at least one or more pieces of information to communicate a brand's one or more representative personas: One or more representative personas; One or more distinct human traits of each persona; One or more meta properties of each persona (e.g., confidence factor and population coverage); One or more meta properties of selected human traits related to a persona (e.g., trait distribution); One or more representative examples of people related to each persona; One or more representative examples of content generated by people associated with a persona (e.g., product reviews/comments); One or more pieces of additional information related to each persona (e.g., products intended for the persona or products liked/purchased by the people associated with the persona); One or more examples of similar brands based on their representative personas (for design brief); One of more examples of branding assets of similar brands based on their representative personas (for design brief).

If the request asks for a final presentation, such information may be presented first in a summary then in detail. Step 724 creates a visual summary of intended content. Such a summary may be a list of persona cards (similar to a deck of baseball cards), each of which depicts a persona and its associated traits. Since each representative persona reflects a group of people with a set of shared traits, another approach is to create a “visual map”, encoding each persona and their relationships. For example, a specific visual map implementation is a treemap, where each cell encodes a representative persona and the size of the cell encodes the coverage of the persona. Other visual elements, such as the texture and color, may also be used to encode other properties of the persona (e.g., smoother texture for more “pure” persona and warm color for warm personality). The other implementation of a visual map is the use of a voronoi diagram where each seed encodes the traits possessed by the representative persona. Similar to the tree map implementation, each voronoi cell encodes a representative persona and the size of the cell encodes the coverage of the persona. Unlike the tree map, the positions of the cells encode the relationships among personas so that more similar personas are placed closer to each other. Yet another implementation is to use a combined treemap and voronoi diagram. At 726, on the other hand, generates a textual description of certain content (e.g., relevant product description).

Based on a summary of representative personas, a human user may navigate among the personas and access more relevant details of a particular persona. Steps 724 and 726 then present the details of a particular representative persona. For example, the final presentation may show additional traits, such as the demographics of the people associated with the persona, “representatives”—real examples of people associated with the persona, relevant products liked/purchased by the people associated with the persona, and information produced by the “representatives” such as reviews and comments. There are many ways to choose “representatives”, e.g., based on their activeness or level of influence. Information produced by the brand, such as a product message, intended for the people associated with this persona, may be included. All selected information may be communicated directly in its original form, summarized (e.g., reviews in word clouds), or depicted graphically (e.g., in charts and diagrams).

In case the presentation request asks for a design brief, the presentation generation steps 724, 726, 728 are skipped. Instead the selected information is sent to step 730 to create a design brief.

Either a design brief or the final presentation is sent to be displayed to a user at 732. A user may interact with the display, whose interactive activities are handled at 734, which may generate one or more new brand presentation requests for further processing.

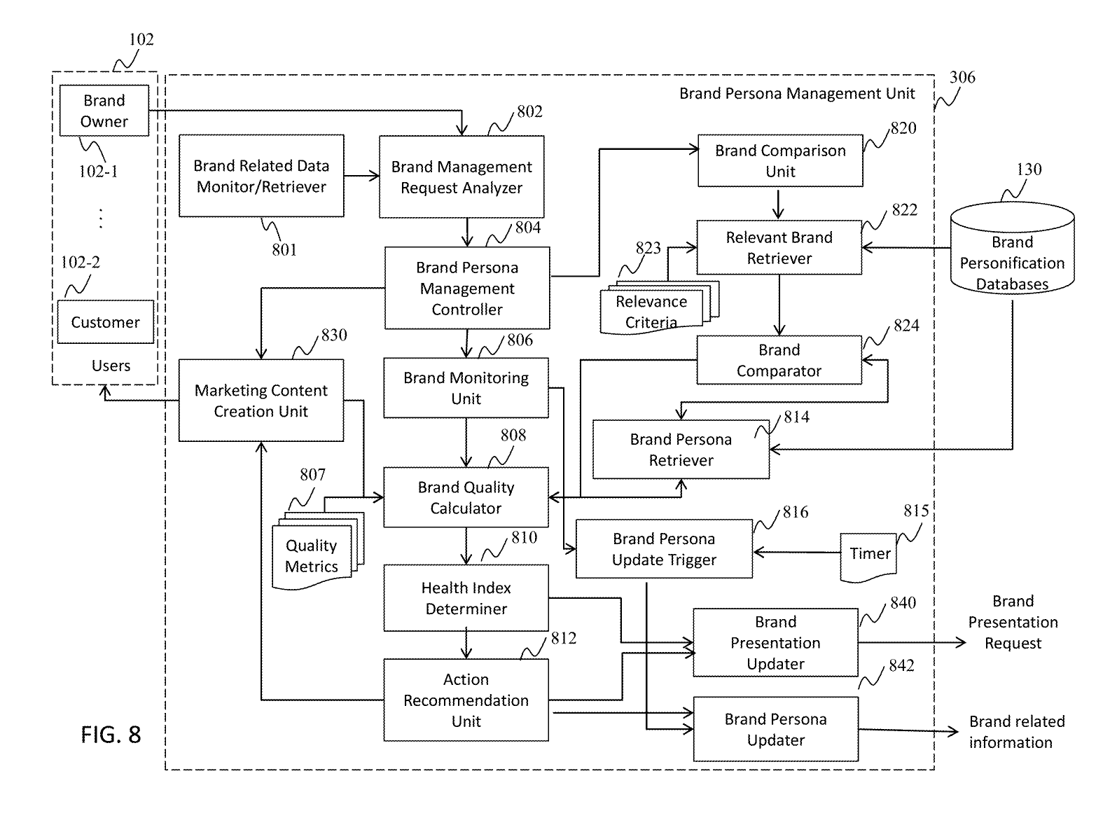

FIG. 8 illustrates an exemplary diagram of a brand persona management unit 306, according to an embodiment of the present teaching. A brand often evolves due to many reasons. For example, it evolves as the needs of their customers have changed. It evolves as the market or economic situation has changed. It also evolves as competitive or complementary brands have emerged or evolved. A brand's personas—self personas and/or representative personas—abstracts the essence of a brand and may serve as a natural barometer to monitor a brand's evolution and its health. Based on a brand's evolution and health, brand actions may then be recommended to help manage and grow the brand. To help various users, such as a brand's owner and manager, to manage a brand systematically, the Brand Persona Management Unit 306 consists of a set of computational components, which together support one or more brand management functions based on a brand's derived personas.

FIG. 8 provides one of the exemplary structural composition of key components in the Brand Presona Management Unit 306. As shown in FIG. 8, depending on how often a brand is managed, a data monitor is set up to specify one or more brand data sources to be monitored (e.g., a brand's website content) and the preferred brand management time interval 801. The data monitor also knows how to retrieve the data in the specified data sources for brand management purpose. Given a brand management request from a user and management information from the Brand Related Data Monitor/Retriever 801, the request analyzer 802 parses the request and formulates a brand management task, which is then forwarded to the task controller 804.

If the brand management task is to perform periodical brand monitoring and management, the controller calls the brand monitoring unit 806. The monitoring unit first checks with the brand persona update trigger 816, which has a timer attached 815. If the timer has not reached the next scheduled update, it does nothing. This also means all the brand personas are up to date. Otherwise, the trigger fires and calls the brand persona updater 842 to request new brand personas to be established using the updated data.

Assume that all brand persons are up to date. In this case, the monitoring unit 802 calls the brand quality calculator 808 to compute one or more brand quality metrics 807 using the up-to-date, derived brand personas retrieved by the Brand Persona Retriever 814. Brand quality metrics measures a brand's quality from one or more aspects based on its derived personas and their associated traits. Here are several exemplary metrics used to measure the quality of a brand:

Consistency metric measures how consist a brand has portrayed itself over time by comparing the similarity of derived self personas from different data sources (e.g., the brand's Facebook posts, the tweets, and the website content). The more similar the personas are, the more consistent the brand has conveyed itself across channels. The similar metric is also used to compare the similarity of a brand's self persona over time (e.g., now and 1 year ago). The more similar the personas are, the more consistent the brand has portrayed itself over time.

Clarity metric to measure how prominent a brand is based on its derived self persona. The more dominate personas it is associated with, the less prominent the brand is.

Coherence metric, which is used to measure how well the content of a brand produces matches with the desired audience. For example, if the brand wants to address a particular representative customer persona or employee persona, this metric helps measure how the intended content match with the target audience. In this case, one approach to the metric calculation is to check how well the word use in the intended content match with the word use by the people associated with the representative persona. Alternatively, another approach is to derive human traits from the intended content and then check how well the “derived traits” match with the traits of the representative persona.

Based on the computed metrics for a given brand such as above, one or more brand health indices are then computed by the Health Index Determiner 810. For example, one health index is computed based on a brand's self personas, while a different index may be calculated based on a brand's customer representative personas. There are multiple approaches to derive a health index based on one or more computed brand metrics. One approach is to use one or more empirical rules to compose a health index based on the computed metric values. Here is an example rule:

IF Consistency is high AND Clarity is high AND Coherence is high THEN health-index=high.

Another approach is to use a machine learning approach to train a model that predicts a health index based on the current metric values. In this approach, a set of training examples is first constructed. Here each example indicates one or more metric values and the associated brand health index. The examples are then used to train a statistical model, which is then used to predict a brand healthy index given one or more brand metric values. More sophisticated approaches that incorporate time series analysis may also be used to forecast the health index for a given time frame based on the past health index values of this brand or other brands over time. Based on the computed brand health indices, the Action Recommendation Unit 812 may recommend proper management actions to the brand. For example, if the health index has decreased due to the decrease of the Clarity metric, it may recommend that the brand sticks to developing one dominate persona. Here management actions may be encoded as part of the knowledge base 140 with their corresponding trigger criteria based on the change of the health index. The proper actions are selected when all the trigger criteria are met. New management actions may also be added during the management process by a brand management expert as business rules.

Another way of managing a brand's persona is to manage it in the context of other brands by the Brand Comparison Unit 820. This requires the retrieval of relevant brands by the Relevant Brand Retriever 822 based on a set of relevance criteria 823. For example, the relevance criteria may indicate the retrieval of competitive brands or complementary brands. Such retrieval criteria may be specified by a user or suggested by the system (e.g, finding similar brands). The retrieved relevant brands are then compared with the brand under management retrieved by the Brand Persona Retriever 814. The brand comparator 824 generates one or more comparison results, such as similarity and differences, which are then sent to the brand quality calculator 808 to compute a set of different brand metrics. For example, the Clarity metric described above now measures how different the brand is from all its competitors. The more different it is, the higher the Clarity metric value. Similarly, the Consistency metric now measures how similar two complementary brands are. The Health Index Determiner 810 then computes one or more different health indices that indicate the health of the brand in the context of other brands. Accordingly, management actions will be recommended by the Action Recommendation Unit 812 for a brand to grow (e.g., developing a different persona to differentiate itself from its competitions or co-brand with a complementary brand based on one or more shared human traits or brand benefits).

Yet another often encountered brand persona management task is on-demand management. One such on-demand management task is to manage a live process of authoring branding or marketing content by the Marketing Content Creation Unit 830. During the content authoring, intermediate results may be measured by one or more brand metrics. For example, when composing a brand blog, the Consistency and Coherence metrics may be computed by the Brand Quality Calculator 808 to measure the quality of the blog message and how well it would resonate with the intended audience—one or more representative personas of the brand. Specifically, the Consistency metric checks how consistent the blog aligns with other branding messages by comparing the brand personality traits derived from this blog and that of the brand. The Coherence metric assesses the similarity of the human traits of the blog with that of the people in the target representative persona. Deriving a blog's “brand personality traits” or other human traits such as Big 5 personality traits is similar to derive such traits of a brand as described earlier (e.g., at 514). Based on these metric values, recommendations (by the Action Recommendation Unit 812) may be provided to guide the revision of the content (e.g., using similar words that are more consistent with other branding messages or that used by the target audience).

Another on-demand management task may be the selection of a suitable spokesperson (e.g., a celebrity) for a brand. The selection process is similar to the evaluation of the branding content as described above. Instead of evaluating the brand's content against one or more metrics, this task evaluates a candidate spokesperson's traits with that of the brand persona as well as the representative persona of the target customers. A spokesperson's traits may be derived using one or more methods, including using the data generated by the spokesperson (e.g., the spokesperson's tweets or Facebook posts or blogs) or based on the perception of others. Again, if it requires the auto-inference a candidate's traits from his/her own data, the similar approaches described at 514 may be used.

The updated brand health indices or recommended actions may be trigger a presentation update request by the Brand Presentation Updater 840 to generate updated presentations to communicate the brand's updated personas or status.

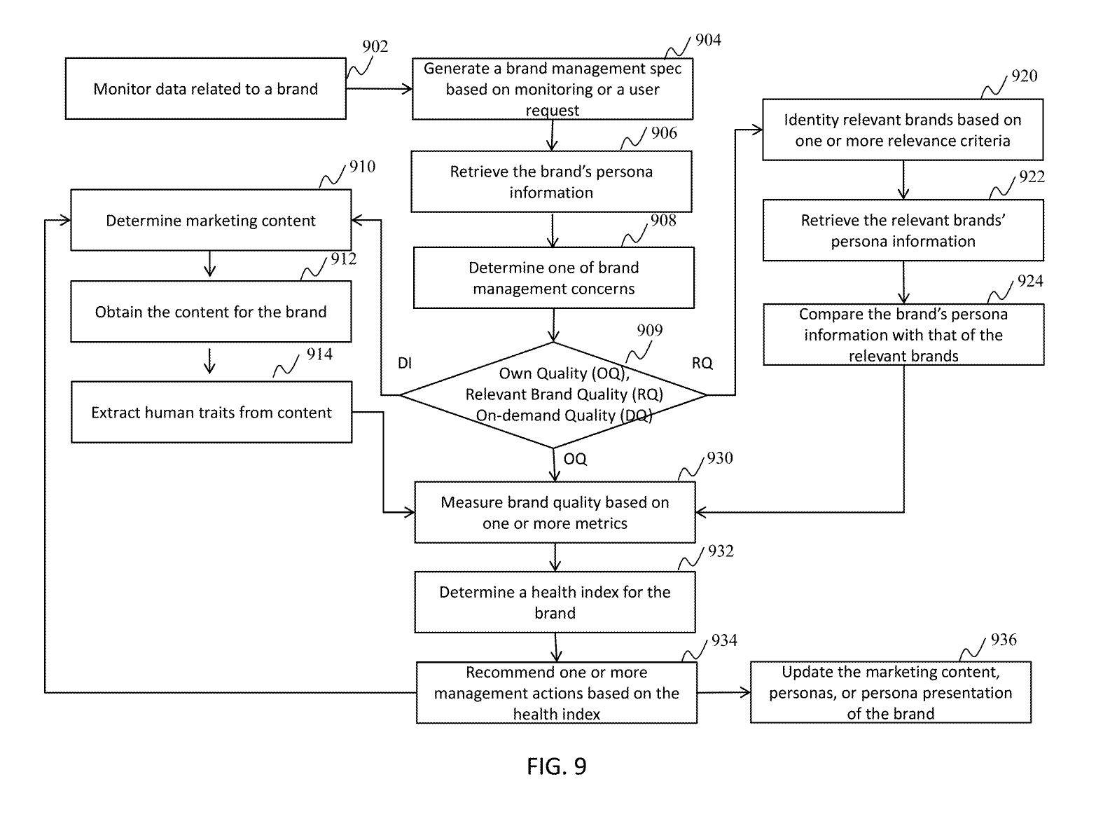

FIG. 9 is a flowchart of an exemplary process performed by a brand persona management unit, according to an embodiment of the present teaching. FIG. 9 describes one or more detailed process flows that handle one or more brand persona management tasks. First, a management task is formulated at 904 either based on a scheduled management specification at 902 or a user request. Per the task, the managed brand's persona information is retrieved at 906 and the task is dispatched depending on its specification at 908. If the task is managing the brand's own quality (OQ), one or more brand quality metrics are computed at 930. Then a health index is determined based on the measured brand quality metrics at 932. Based on the derived health index, one or more management actions may be recommended as described earlier at 934. The recommended actions may trigger the updates of relevant information, such as the brand's persona and marketing content at 936.

If the management task is to manage the brand in the context of other brands (RQ), one or more relevant brands are identified based on one or more relevant criteria at 920. The identified brands' information is then retrieved from the brand database at 922. The retrieved brand information is sent to be compared with the brand under management 924. The comparison result is used to calculate one or more brand's quality metrics at 930, which helps determine another health index at 932. Depending on the health index, one or more actions may be recommended at 934 and are used to update the brand's personas and other related information.

If the management task is to manage the brand on demand (DQ), the live process of determining the brand's marketing content is then invoked at 910. Note that this process may be composing a brand's marketing message on the fly or evaluating a brand's spokesperson. In any case, the content (e.g., the marketing message content or the spokesperson's speech) is retrieved at 912 and processed to extract relevant human traits at 914. The results are then used to calculate one or more brand quality metrics at 930, which then are used to compute the brand's health index at 932. Similar to the above, the health index may trigger one or more action recommendations at 934. The recommendations are sent to the live process to help revise the marketing content or selection of a spokesperson at 910.

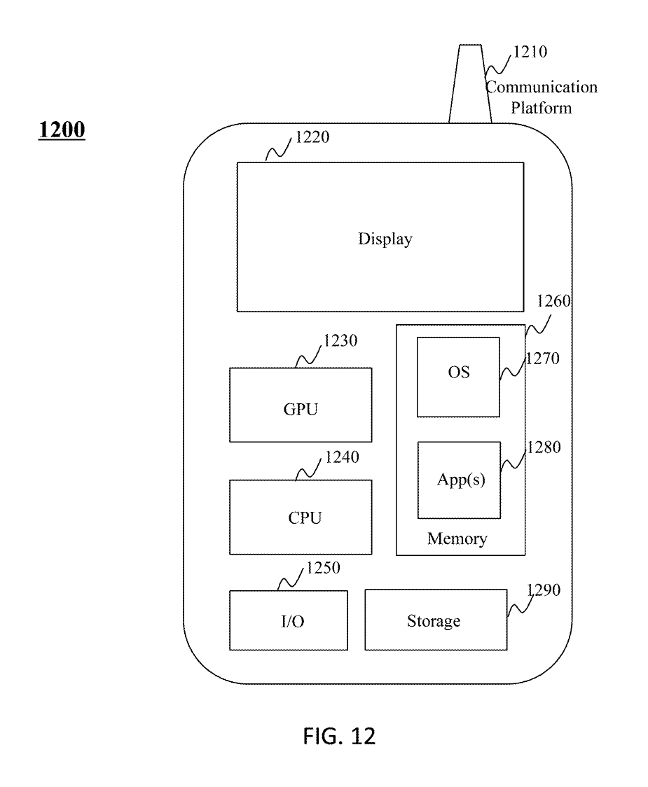

FIG. 12 depicts the architecture of a mobile device which can be used to realize a specialized system implementing the present teaching. In this example, the user device on which brand personification is requested and received is a mobile device 1200, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1200 in this example includes one or more central processing units (CPUs) 1240, one or more graphic processing units (GPUs) 1230, a display 1220, a memory 1260, a communication platform 1210, such as a wireless communication module, storage 1290, and one or more input/output (I/O) devices 1250. Any other suitable component, including but not limited to a system bus or a controller (not shown), may also be included in the mobile device 1200. As shown in FIG. 12, a mobile operating system 1270, e.g., iOS, Android, Windows Phone, etc., and one or more applications 1280 may be loaded into the memory 1260 from the storage 1290 in order to be executed by the CPU 1240. The applications 1280 may include a browser or any other suitable mobile apps for requesting brand personification on the mobile device 1200. User interactions with the information about brand personification may be achieved via the I/O devices 1250 and provided to the brand personification engine 120 and/or other components of systems 100 and 200, e.g., via the network 110.

To implement various modules, units, and their functionalities described in the present disclosure, computer hardware platforms may be used as the hardware platform(s) for one or more of the elements described herein (e.g., the brand personification engine 120 and/or other components of systems 100 and 100 described with respect to FIGS. 1-11). The hardware elements, operating systems and programming languages of such computers are conventional in nature, and it is presumed that those skilled in the art are adequately familiar therewith to adapt those technologies to brand personification as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

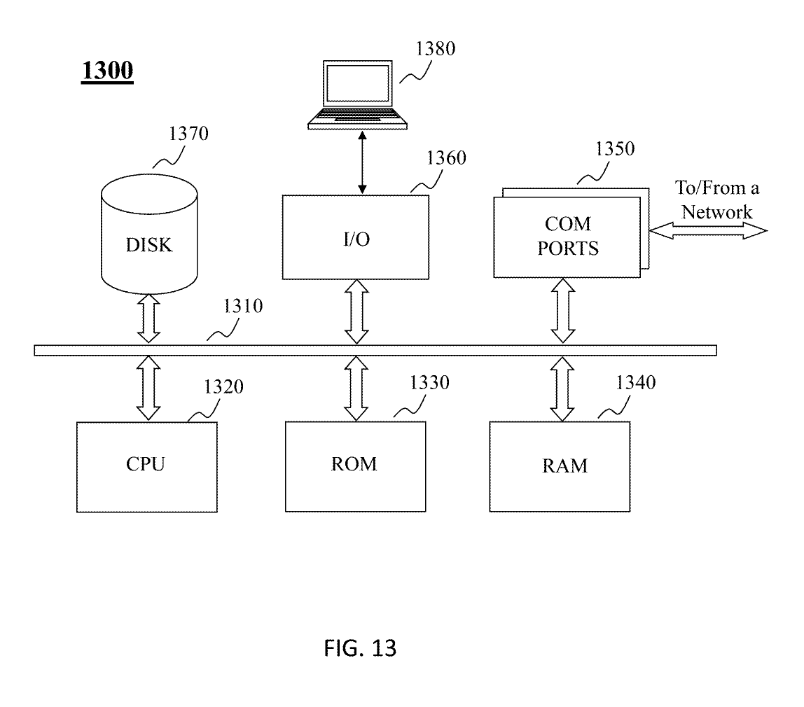

FIG. 13 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1300 may be used to implement any component of the brand personification techniques, as described herein. For example, the brand personification engine 120, etc., may be implemented on a computer such as computer 1300, via its hardware, software program, firmware, or a combination thereof. Although only one such computer is shown, for convenience, the computer functions relating to brand personification as described herein may be implemented in a distributed fashion on a number of similar platforms, to distribute the processing load.

The computer 1300, for example, includes COM ports 1350 connected to and from a network connected thereto to facilitate data communications. The computer 1300 also includes a central processing unit (CPU) 1320, in the form of one or more processors, for executing program instructions. The exemplary computer platform includes an internal communication bus 1310, program storage and data storage of different forms, e.g., disk 1370, read only memory (ROM) 1330, or random access memory (RAM) 1340, for various data files to be processed and/or communicated by the computer, as well as possibly program instructions to be executed by the CPU. The computer 1300 also includes an I/O component 1360, supporting input/output flows between the computer and other components therein such as user interface elements 1380. The computer 1300 may also receive programming and data via network communications.

Hence, aspects of the methods of brand personification, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the brand personification as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a machine having at least one processor, storage, and a communication platform connected to a network for personifying a brand, the method comprising:
receiving information associated with a brand;
retrieving, based on the received information, data related to the brand, wherein the data includes information indicative of desired market impression associated with the brand; and
transforming the data to derive at least one brand persona that characterizes the brand based on the information.

2. The method of claim 1, wherein the transforming further comprises:
automatically transforming the data into one or more human traits from the data; and
deriving the at least one brand persona of the brand from the one or more human traits.

3. The method of claim 1, wherein the data further comprises at least one of the following:
second information related to impressions expressed by people with respect to the brand;
third information related to communications and expressions of the brand; and
fourth information indicative of at least one virtual persona that describes a type of people relating to the brand.

4. The method of claim 2, further comprising deriving a brand personality trait characterizing the brand from the one or more human traits.

5. The method of claim 1, further comprising at least one of:
generating an instruction for presenting the brand with a marketing message; and
generating a marketing message to be utilized for presenting the brand.

6. The method of claim 5, wherein at least one of the instruction and the marketing message comprises information related to at least one of the following:
a description of the at least one brand persona;
a human trait associated with the at least one brand persona;
a trait score corresponding to the human trait;
a representative person associated with the at least one brand persona;
content generated by the representative person;
a second brand having a brand persona similar to the at least one brand persona;
a branding asset associated with the second brand; and
a product or service associated with the at least one brand persona.

7. The method of claim 1, further comprising:
monitoring dynamic information related to the brand and/or the at least one brand persona; and
updating the brand based on the dynamic information.

8. The method of claim 7, wherein monitoring dynamic information further comprises measuring a health status of the brand.

9. The method of claim 8, wherein measuring a health status of the brand further comprises calculating one or more health quality metrics based on the information related to the brand.

10. The method of claim 7, wherein monitoring dynamic information further comprises measuring a quality status of the brand's marketing content during its composition.

11. The method of claim 7, further comprising comparing the brand with one or more other brands based on their respective brand personas to generate a comparison result.

12. A system having at least one processor, storage, and a communication platform connected to a network for personifying a brand, the system comprising a brand persona establishment unit configured for:
receiving information associated with a brand;
retrieving, based on the received information, data related to the brand, wherein the data includes information indicative of desired market impression associated with the brand; and
transforming the data to derive at least one brand persona that characterizes the brand based on the information.

13. The system of claim 12, wherein the brand persona establishment unit further comprises:
a brand related human trait determiner configured for automatically transforming the data into one or more human traits from the data; and
a brand persona determiner configured for deriving the at least one brand persona of the brand from the one or more human traits.

14. The system of claim 12, wherein the data further comprises at least one of the following:
second information related to impressions expressed by people with respect to the brand;
third information related to communications and expressions of the brand; and
fourth information indicative of at least one virtual persona that describes a type of people relating to the brand.

15. The system of claim 13, wherein the brand persona establishment unit further comprises a brand personality trait determiner configured for deriving a brand personality trait characterizing the brand from the one or more human traits.

16. The system of claim 12, further comprising a brand persona presentation unit configured for:
generating an instruction for presenting the brand with a marketing message; and
generating a marketing message to be utilized for presenting the brand.

17. The system of claim 16, wherein at least one of the instruction and the marketing message comprises information related to at least one of the following:
a description of the at least one brand persona;
a human trait associated with the at least one brand persona;
a trait score corresponding to the human trait;
a representative person associated with the at least one brand persona;
content generated by the representative person;
a second brand having a brand persona similar to the at least one brand persona;
a branding asset associated with the second brand; and
a product or service associated with the at least one brand persona.

18. The system of claim 12, further comprising a brand persona management unit configured for:
monitoring dynamic information related to the brand and/or the at least one brand persona; and
updating the brand based on the dynamic information.

19. The system of claim 18, wherein the brand persona management unit further comprises at least one of the following:
a health index determiner configured for measuring a health status of the brand; and
a brand quality calculator configured for calculating one or more health quality metrics based on the information related to the brand.

20. The system of claim 18, wherein the brand persona management unit further comprises at least one of the following:
a marketing content creation unit configured for measuring a quality status of the brand's marketing content during its composition; and
a brand comparator configured for comparing the brand with one or more other brands based on their respective brand personas to generate a comparison result.
